(19) United States
(12) Patent Application Publication
(10) Pub. No.: US 2004/0191726 A1
(43) Pub. Date: Sep. 30, 2004

(54) Sinus bolt retention system

(76) Inventor: Jose Lucente, Hypoluxo, FL (US)

Correspondence Address: Michael A. Slavin, McHale & Slavin, P.A., 2855 PGA Boulevard, Palm Beach Gardens, FL, 33410, US

(21) Appl. No.: 10/397,590

(22) Filed: Mar. 26, 2003

(51) Int. Cl. A61C 8/00

(52) U.S. Cl. 433/173

(57) ABSTRACT

A sinus bolt retention system includes a guide for precisely aligning a sinus support and an implant post for attachment through a bone. The sinus support is a bio-compatible material shaped to closely approximate the internal form of the sinus of the bone. The implant post extends from the outer surface of the bone through a bore hole to engage the sinus support. A denture may be immediately fitted to the implant post.

### BACKGROUND OF THE INVENTION

1. Field of the Invention

The invention is related to the field of dental implants.

2. Description of the Prior Art

Loss of teeth is generally followed by bone loss or resorption in the supporting anatomical structures. Osseointegrated implants have become the treatment of choice for the replacement of missing teeth. However, the primary prerequisite for using dental implants is the availability of supporting bone in adequate quantity (thickness) and quality (strength).

Severe bone loss has been treated by bone regeneration techniques using bone grafts, with an acceptable degree of success. In the last few years synthetic materials have been used in place of bone. The loss of teeth coupled with severe bone resorption and pneumatization of the maxillary sinus precludes the use of endosseous implants without bone augmentation by grafting. The basic aim of the procedure referred to as a sinus lift is to introduce grafting material into the maxillary sinus by a surgical opening in the external wall of the sinus.

After reflection of the sinus membrane, the grafting material is placed in direct contact with the bone. This is crucial because the graft must come in direct contact with the bone of the sinus floor in order to become a part of the bone. A sinus lift procedure is indicated when the height of the residual ridge is less than 8 mm.

Permanent dental implants are obtained by attaching a fixture to the jaw bone or mandible to provide a mount for an artificial tooth. Implants may also be placed in the maxilla. Usually, a fixture is inserted into the bone and the denture is affixed to the fixture. However, in some cases the bone is so thin that the fixture may not remain stable under the normal forces of use. There are implant procedures for inserting different materials into the sinus of the bone to build up support for a denture.

U.S. Pat. No. 5,456,601 issued to Sendax discloses a procedure to surgically access the sinus of the supporting bone to place a stabilized threaded post in the sinus to extend through the gum for mounting a denture. The stabilized post will eventually be incorporated within the bone and form a solid foundation for the denture. The surgical procedure described requires operating in the blind, without guidance, to drill or otherwise form an aperture medially through the bone into the sinus to connect with another pre-formed aperture cut laterally through the bone. A nut is inserted through he lateral opening and a post is inserted through the medial aperture and threaded together. After sufficient time has passed for the nut to become embedded in the bone, the post may serve as support for a denture.

What is needed in the art is a device to obtain immediate fixation and loading of endosseous implants in the atrophic edentulous area below the sinus floor without the use of grafting material.

### SUMMARY OF THE PRESENT INVENTION

A sinus bolt retention system having a guide for precisely aligning a sinus support and an implant fixture for attachment through a bone. The sinus support is a bio-compatible material shaped to closely approximate the internal form of the sinus of the bone. The implant post extends from the outer surface of the bone through a bore hole to engage the sinus support. A denture may be immediately fitted to the implant post.

The sinus bolt retention system of this invention is of particular benefit in placing implants in the maxilla with support in the maxillary sinus.

Therefore, it is an objective of this invention to provide a surgical appliance for orienting the elements of a dental implant with each other and the recipient's anatomy.

It is another objective of this invention to assure proper orientation of the aperture and post in relation to the gum line, the axis of the bone and the location of the denture. The device should also guide the connection of the post and support.

It is a further objective, to provide a dental implant including a post and a support for the post that will maximize the surface contact between the wall of the sinus and the support to allow immediate placement of the denture.

### BRIEF DESCRIPTION OF THE DRAWINGS

FIG. 1 is a side view of the sinus bolt retention system of this invention in place within a cross section of the maxilla;

FIG. 2 is a side view of the sinus bolt retention system with an implant mount aligned and a tool;

FIG. 3 is a side view of the implant and support in place;

FIG. 4 is an exploded side view of the components of the sinus bolt retention system;

FIG. 5 is a side view of the sinus support; and

FIG. 6 is a top view of the guide arm with a support.

### DETAILED DESCRIPTION OF THE INVENTION

FIG. 1 illustrates the operational environment of the sinus bolt retention system with the guide 11 in place with the distal end 13 of the superior arm 12 inserted through the lateral maxilla flap F into the maxillary sinus S. The system is described in relation to the maxilla M but may be used to place implants in the mandible, also.

The proximal end 14 of the superior arm 12 is connected to the upper end 16 of the vertical arm 15. The distal end 13 of the superior arm 12 has an opening 18 to receive the support 30. A set screw 19 extends through the superior arm with a head 20 and a distal end 21 securing support 30 in place.

The bottom end 17 of the vertical arm 15 is movably attached with the proximal end 23 of lower arm 22. The distal end 24 of the lower arm has a threaded aperture 25 with an axis parallel with the axis of the vertical arm 15. The lower arm 22 is movable along the length of the vertical arm 15 to adjust the separation of the distal ends of the guide 11 to accommodate different anatomical sinus heights. A burr guide 26 is shown threaded into the aperture 25 to guide the drill. The burr guide 26 directs the formation of a bore through the bone to precisely align the sinus support 30 with the shaft of the implant 31 and, ultimately, the location of the denture.

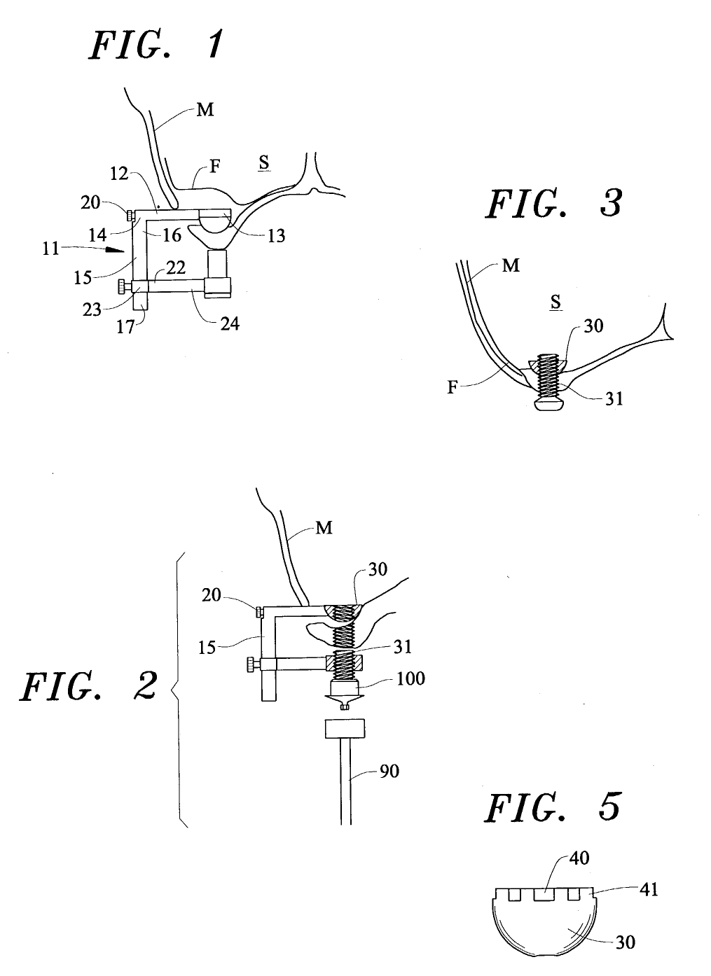

As shown in FIG. 2, an implant 31 is inserted through the bore and threaded into the sinus support 30. The sinus support functions to create sufficient thickness for stabilizing a denture. The sinus support is shaped to closely engage the inner surface of the sinus. The shape of the support increases the area of contact between the implant and the bone and serves to spread the load over a larger area to further stabilize the implant. The tool 90, which may be attached to a drill, is used to rotate the mount 100 fitted onto the implant 31. Once the implant is connected with the support, the mount is removed from the implant. As shown, there may be more than one burr guide of different lengths to accommodate different bone structures. Also, the diameter of the burr guides and the implant may be the same or the implant may tap through the bone to screw into the sinus support 30.

FIG. 3 illustrates the final position of the sinus support 30 and the implant 31. The denture may be immediately fitted if desired. Another option would be to add grafting material to the sinus about the sinus support.

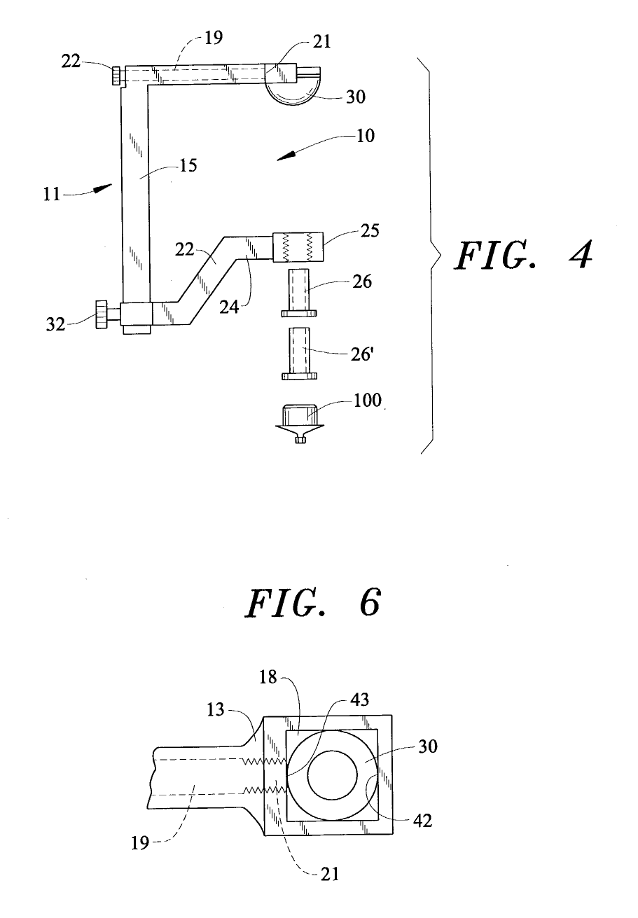

The sinus bolt retention system 10 is shown in FIG. 4. The system 10 includes the guide 11, a sinus support 30, burr guide 26 and other burr guides 26′ of different lengths, and a denture mount 100. The lower arm may be angulated, as shown, to accommodate different bone thicknesses. The lower arm 22 is movable along the axis of the vertical arm 15 by sliding with a set screw 32 to lock the relative position and the distance between the superior arm and the lower arm. The arms may be adjustable by other devices, such as screw threads or rachet and pawl.

The sinus support 30 is made from a biocompatible material, such as titanium, with suitable strength to withstand the forces of use. The support is shaped to complement the sinus surfaces closely. A bore 40 extends through the support 30 and is threaded to accept the threads of the implant 31. The upper surface of the support has a shaped projection 41 for fitting into the opening 18 in the superior arm.

The projection 41 is shown, in FIG. 6, as circular with flattened areas 42, 43 to prevent support 30 from rotation in the opening 18. The distal end 21 of the set screw 19 is threaded through the wall of the opening 18 to contact and lock the support in the superior arm during connection of the support 30 and the implant 31. The shape of the opening and the projection may take other forms, as long as there is no relative rotation between the components.

Once the implant and the support are secured together, the guide is removed and the flap is closed by conventional procedures. Of particular importance in this procedure, is the location of the lateral surgical opening in the maxilla. The incision should provide an opening as close to the floor of the sinus as possible.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

What is claimed is:

1. A sinus bolt retention system for mounting a dental implant in a bone comprising a guide with a superior arm having a proximal end and a distal end, said distal end adapted to be inserted into a bone, said proximal end of said superior arm connected to the top end of a vertical arm, said distal end of said superior arm including an opening for removably carrying a sinus support for placement in the bone, said vertical arm having a lower end movably connected to a proximal end of a lower arm, said lower arm having a distal end with an opening adapted for guiding an implant post therethrough, said opening in said distal end of said lower arm aligned with said opening in said distal end of said superior arm whereby said implant post is accurately engaged through said bone with said support.

2. A sinus bolt retention system of claim 1 further comprising said sinus support having a central bore, said bore having internal threads, said bore aligned with said opening in said superior arm, said implant post having exterior threads adapted to engage said internal threads of said bore.

3. A sinus bolt retention system of claim 1 further comprising said opening in said superior arm having shaped sidewalls, said sinus support having a projection on one surface, said projection having shaped walls complementary with said shaped sidewalls of said opening.

4. A sinus bolt retention system of claim 3 further comprising a bore in said sinus support, said bore having internal threads, said bore extending through said projection, said implant post having external threads for engaging said internal threads.

5. A sinus bolt retention system of claim 3 further comprising a set screw extending through said superior arm from said proximal end to said distal end, said distal end of said set screw adapted to contact said projection.

6. A sinus bolt retention system of claim 1 further comprising a set screw in said proximal end of said lower arm, said set screw contacting said vertical arm, said set screw adapted to lock said lower arm and said vertical arm together as desired.

7. A sinus bolt retention system of claim 1 further comprising internal threads in said opening in said lower arm, a tubular burr guide having external threads, said burr guide threaded in said opening of said lower arm for aligning a bore through the bone with said vertical arm.

8. A dental implant for anchoring a denture in bone comprising a sinus support adapted to be removably mounted in a guide, said sinus support having a shape approximating the internal shape of a bone, said sinus support having a bore therethrough, said bore having internal threads, said sinus support having a means to prevent relative rotation between said sinus and said guide and an elongated implant post having an enlarged end, said elongated post having external threads whereby said sinus support is adapted to be placed in a sinus of a bone, said implant post is adapted to extend from said outer surface of said bone and connect to said sinus support with said external threads engaging said internal threads and said enlarged end of said post adapted to fix a denture.

9. The method of using a sinus bolt retention system to place a dental implant comprising the steps of surgically accessing the interior of a bone, providing a guide having a vertical arm adjustably joined at the top end with a superior arm and the bottom end with a lower arm, said superior arm having a proximal end attached to said top end of said vertical arm and a distal end with an opening, placing a sinus support in said opening in said distal end of said superior arm, inserting said distal end of said superior arm into said interior of said bone, said lower arm having a proximal end connected to said bottom of said vertical arm and a distal end having an opening, said opening in said superior arm aligned with said opening in said lower arm, adjusting said superior arm and said lower arm along said vertical arm to the desired distance, inserting an implant bolt through said opening in said lower arm, connecting said implant bolt with said sinus support and removing said guide.
